(19) United States
(12) Patent Application Publication
(10) Pub. No.: US 2026/0059386 A1
(43) Pub. Date: Feb. 26, 2026

(54) DISTRIBUTED DATA CENTERS

(71) Applicant: Span.IO, Inc., San Francisco, CA (US)

(72) Inventor: Archan Rao, San Francisco, CA (US)

(21) Appl. No.: 18/815,368

(22) Filed: Aug. 26, 2024

(51) Int. Cl. H04W 28/082; H04L 43/08

(52) U.S. Cl. CPC H04W 28/082; H04L 43/08

(57) ABSTRACT

A distributed compute system may include a plurality of compute nodes located in geographically distributed sites. A data processing task is performed in a distributed manner among the plurality of compute nodes. The distributed compute system may include a first power management unit located in a first site of the geographically distributed sites. The first site consumes electrical power for both a first compute nodes of the plurality of compute nodes and for a non-data processing load. The first power management unit monitors power consumption at the first site. An allocation of the data processing task to the first compute node is controlled at least partially based on power consumption at the first site monitored by the first power management unit.

### TECHNICAL FIELD

The instant disclosure is related to a distributed data center, in particular, to compute nodes of the distributed data center that can be installed at various distributed sites such as residential units.

### BACKGROUND

As artificial intelligence (AI) computation becomes more prevalent, there is a significant increase in power consumption across data centers and distributed computing networks. AI models, particularly large-scale machine learning models such as neural networks and deep learning frameworks, require extensive computational resources for both training and inference. This has led to a substantial rise in energy demand, as the processing of large datasets and the execution of complex algorithms necessitate continuous operation of high-performance processors, including CPUs, GPUs, and TPUs. The power required to sustain these operations has escalated rapidly, particularly as the adoption of AI technologies expands across various industries. For instance, the energy consumption of a single AI-driven search query can be an order of magnitude greater than that of a traditional search query, reflecting the intensive computational load. As a result, AI-driven data centers are projected to account for a growing percentage of global electricity usage, necessitating the development of more efficient power management systems and infrastructure enhancements to accommodate this surge. The increase in power consumption poses challenges related to sustainability, cost, and resource allocation, driving the need for innovations in energy-efficient computing and the deployment of distributed power management solutions.

### SUMMARY

In some embodiments, the disclosure described herein relates to a distributed compute system including: a plurality of compute nodes located in geographically distributed sites, wherein a data processing task is performed in a distributed manner among the plurality of compute nodes; and a first power management unit located in a first site of the geographically distributed sites, wherein the first site consumes electrical power for both a first compute nodes of the plurality of compute nodes and for a non-data processing load, and wherein the first power management unit monitors power consumption at the first site, wherein an allocation of the data processing task to the first compute node is controlled at least partially based on power consumption at the first site monitored by the first power management unit.

In some embodiments, the disclosure described herein relates to a distributed compute system, wherein the first site is a residential unit, the non-data processing load is a residential load, and the first power management unit is an electrical panel for the residential unit.

In some embodiments, the disclosure described herein relates to a distributed compute system, wherein the plurality of compute nodes include a plurality of graphical processing units or tensor processing units that are installed at residential units, and the geographically distributed sites include the residential units.

In some embodiments, the disclosure described herein relates to a distributed compute system, wherein the geographically distributed sites further include a second site which is a commercial data center that includes a set of second compute nodes.

In some embodiments, the disclosure described herein relates to a distributed compute system, wherein the first compute node is connected to a battery that is configured to store energy, and wherein the battery is configured to provide power to the non-data processing load and the first compute node.

In some embodiments, the disclosure described herein relates to a distributed compute system, wherein the first site includes a first electrical panel configured to measure the power consumption of the first compute node and a second electrical panel configured to measure the power consumption of the non-data processing load, wherein the first electrical panel is the first power management unit.

In some embodiments, the disclosure described herein relates to a distributed compute system, wherein the first power management unit is connected to a set of modular compute nodes, the set of modular compute nodes is removable and addable individually node by node at the first site.

In some embodiments, the disclosure described herein relates to a distributed compute system, wherein the data processing task is requested by a source and latencies from the plurality of compute nodes to the source are measured to determine the distribution of the compute for the data processing task based on the latencies.

In some embodiments, the disclosure described herein relates to a distributed compute system, wherein a distribution of the compute for the data processing task is determined by: receiving rate plan information of the geographically distributed sites; allocating power consumption of the compute among the plurality of compute nodes based on the rate plan information; and regulating a determined allocation of the power consumption through the plurality of power management units.

In some embodiments, the disclosure described herein relates to a distributed compute system, wherein at least a subset of compute nodes are connected over a wireless mesh network to form a zonal aggregation point, and the subset of compute nodes is configured to be used as a network node in the wireless mesh network.

In some embodiments, the disclosure described herein relates to a system including: a stack of processors serving as a compute node, the stack of processors installed at a residential unit, the stack of processors being part of a distributed data center, which performs a data processing task and includes a plurality of compute nodes that perform the data processing task in a distributed manner; and a power management unit located in the residential unit, the power management unit is configured to manage power consumption of a residential load of the residential unit and power consumption of the stack of processors, wherein an allocation of the data processing task to the stack of processors is at least partially based on power consumption at the residential unit monitored by the power management unit.

In some embodiments, the disclosure described herein relates to a system, wherein the power management unit is an electrical panel for the residential unit.

In some embodiments, the disclosure described herein relates to a system, wherein the stack of processors is data-center graded and not personal computer processors.

In some embodiments, the disclosure described herein relates to a system, wherein at least one of the compute nodes is located at a commercial data center that includes a set of compute nodes.

In some embodiments, the disclosure described herein relates to a system, wherein the stack of processors is connected to a battery that is configured to store energy, and wherein the battery is configured to provide power to the residential load and the stack of processors.

In some embodiments, the disclosure described herein relates to a system, wherein the battery and the stack of processors are connected to a bi-directional inverter.

In some embodiments, the disclosure described herein relates to a system, wherein the stack of processors is part of a set of modular compute nodes, and the set of modular compute nodes is removable and addable individually stack by stack at the residential unit.

In some embodiments, the disclosure described herein relates to a system, wherein the data processing task is requested by a source, and a latency from the stack of processors to the source is measured to determine the allocation for the data processing task based on the latency.

In some embodiments, the disclosure described herein relates to a system, wherein a distribution of the compute for the data processing task is determined by: receiving rate plan information of geographically distributed sites; allocating power consumption of the compute among the plurality of compute nodes based on the rate plan information; and regulating a determined allocation of the power consumption through the plurality of power management units.

In some embodiments, the disclosure described herein relates to a system, wherein the power management unit and additional power management units are connected over a wireless mesh network to form a zonal aggregation point and the power management units are configured to be used as a network node in the wireless mesh network.

In some embodiments, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 is a block diagram of a system environment of a distributed data center, in accordance with some embodiments.

FIG. 2A is a conceptual diagram illustrating a micro data center (MDC) at a geographically distributed site, in accordance with some embodiments.

FIG. 2B is a conceptual diagram illustrating a micro data center (MDC) at another geographically distributed site, in accordance with some embodiments.

FIG. 2C is a conceptual diagram illustrating a configuration where the power management unit serves as a sub-panel, in accordance with some embodiments.

FIG. 3 is a conceptual diagram illustrating modular data centers, in accordance with some embodiment.

FIG. 4 is a conceptual diagram illustrating a network cluster formed by a local group of compute nodes, in accordance with some embodiments.

FIG. 5A is an end user's view of the modular electrical panel, in accordance with some embodiments.

FIG. 5B is a view of the electrical panel with the dead front panel removed and many of the modular dead front panels removed, in accordance with some embodiments.

FIG. 6 is a perspective diagram of the electrical panel with a different arrangement of electrical modules, in accordance with some embodiments.

FIG. 7 is a flowchart depicting a process for allocating data processing tasks to a plurality of compute nodes in a distributed data center, in accordance with some embodiments.

The figures depict, and the detailed description describes various non-limiting embodiments for purposes of illustration only.

### DETAILED DESCRIPTION

The figures(FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

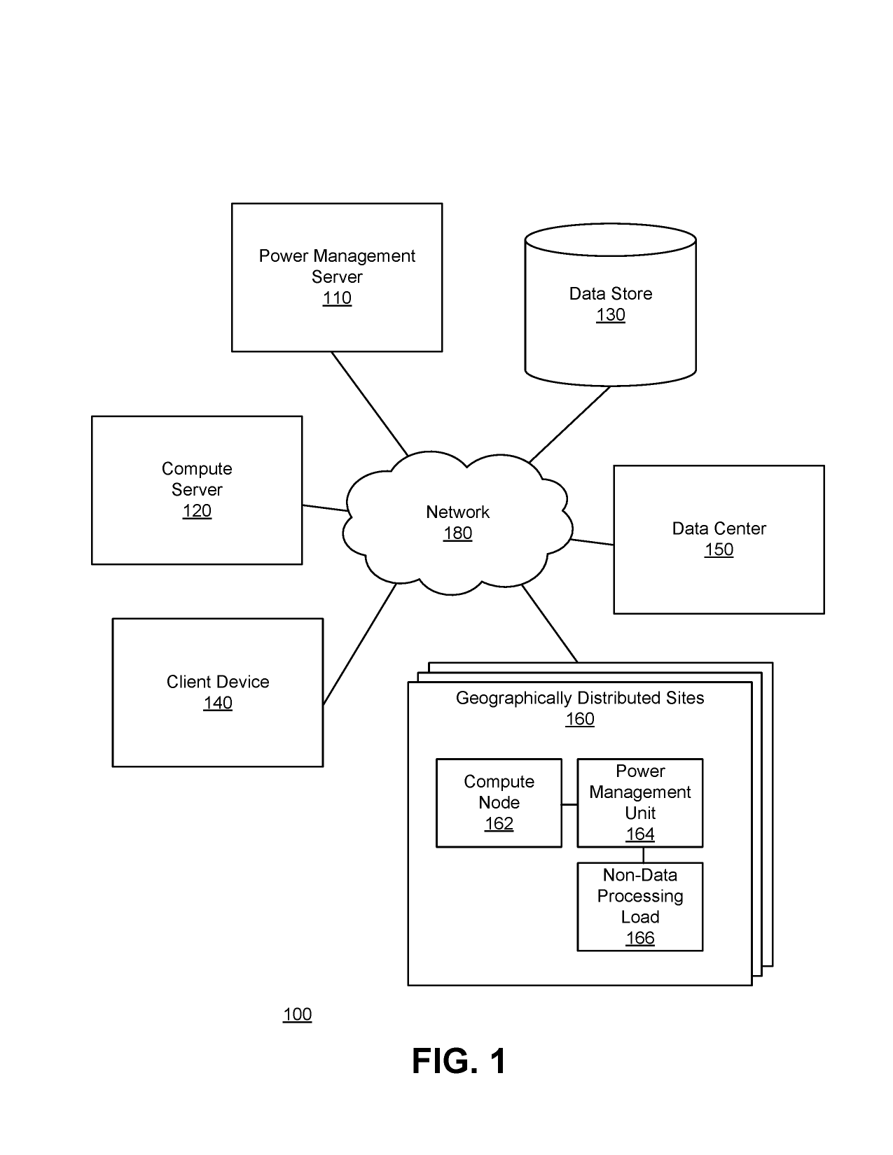

FIG. 1 is a block diagram that illustrates an example of an environment 100 for a distributed data center, in accordance with some embodiments. By way of example, the computing environment 100 includes a power management server 110, a compute server 120, a data store 130, a client device 140, a data center 150, and geographically distributed sites 160. The entities and components in the computing environment 100 may communicate with each other through one or more different types of networks 180. In various embodiments, the computing environment 100 may include different, fewer, or additional components.

The components in the computing environment 100 may each correspond to a separate and independent entity or may be controlled by the same entity. For example, in some embodiments, the power management server 110 and the compute server 120 are the same component and are operated by the same entity. In other embodiments, the power management server 110 and the compute server 120 are operated by different entities where the power management server 110 provides power bandwidth information to the compute server 120 to determine the allocation of compute among various compute nodes 162. Likewise, each geographically distributed site 160 may be controlled by a different entity.

While each of the components in this disclosure is sometimes described in disclosure in a singular form, the computing environment 100 and elsewhere in this disclosure may include one or more of each of the components. For example, there can be multiple client devices 140 requesting data processing tasks that require the use of various compute nodes 162 to perform a compute task in a distributed manner. While a component may be described in this disclosure in a singular form, it should be understood that, in various embodiments, the component may have multiple instances. Likewise, while some of the components are described in a plural form, in some embodiments each of those components may have only a single instance in the computing environment 100.

The power management server 110 may provide and manage the power bandwidth data of various compute nodes 162 in a distributed data center. A distributed data center is a distributed compute network. The power management server 110 may provide the information needed for the allocation of data processing tasks across various compute nodes 162 by optimizing the utilization of power resources. In some embodiments, the power management server 110 may monitor the power consumption and the rate plan information of each geographically distributed site 160 and provide the information to the compute server 120 for the determination of the allocation of computes among the various compute nodes 162 in the distributed data center. For example, the power management server 110 may gather real-time power consumption data from each power management unit 164 that is installed at each geographically distributed site 160 and provide power bandwidth data to the compute server 120. In some embodiments, the power management server 110 may also monitor the consumption patterns of both compute nodes and non-data processing loads 166. The computational tasks among the compute nodes 162 may be allocated dynamically based on real-time power availability to optimize overall system performance and reduce potential power-related bottlenecks. In some embodiments, the power management server 110 may also control the allocation of data processing tasks to compute nodes 162 based on power consumption data provided to the power management server 110 to prevent the overloading of power circuits at geographically distributed site 160.

In some embodiments, the power management server 110 may be operated by the same entity that manufactures power management units 164 installed at geographically distributed sites 160. For example, the power management server 110 may be the server that is in communication with the power management units 164 to collect power usage data from the power management units 164 and transmit commands to the power management units 164 on the allocation of power usage. In some embodiments, the compute tasks may be routed from the compute server 120 to the power management server 110 to cause the various compute nodes 162 to perform the tasks in a distributed manner. In other embodiments, the compute server 120 may directly control the allocation of the compute tasks based on the power bandwidth information provided by the power management server 110. In some situations, for simplicity, the power management server 110 may also refer to the entity that operates the power management server 110.

In various embodiments, the power management server 110 may take different suitable forms. For example, while the power management server 110 is described in a singular form, the power management server 110 may include one or more computers that operate independently, cooperatively, and/or distributively. In various embodiments, the power management server 110 may be a single server or a distributed system of servers that function collaboratively. It may be implemented as a cloud-based service, a local server, or a hybrid system that powers management server 110 in both local and cloud environments. In some embodiments, the power management server 110 may be a server computer that includes one or more processors and memory that stores code instructions that are executed by one or more processors to perform various processes described herein. In some embodiments, the power management server 110 may also be referred to as a computing device or a computing server. In some embodiments, the power management server 110 may be a pool of computing devices that may be located at the same geographical location (e.g., a server room) or be distributed geographically (e.g., cloud computing, distributed computing, or in a virtual server network). In some embodiments, the power management server 110 may be a collection of servers that independently, cooperatively, and/or distributively provide various products and services described in this disclosure. The power management server 110 may also include one or more virtualization instances such as a container, a virtual machine, a virtual private server, a virtual kernel, or another suitable virtualization instance.

In some embodiments, the power management server 110 may provide client devices 140 and/or operators of the compute server 120 with power management and analytics tools as a form of cloud-based software, such as software as a service (SaaS) through the network 180.

The compute server 120 receives compute commands from a client device 140 and allocates the corresponding data processing tasks among the various compute nodes 162 located in geographically distributed sites 160 and/or within a data center 150. The compute tasks can include various types of data processing operations, such as training large machine learning models, making inferences in large machine learning models, performing complex simulations, executing distributed algorithms, mining cryptocurrency, etc. The compute server 120 ensures that these tasks are efficiently distributed, taking into account the processing power, latency, and power availability at each compute node. For example, upon receiving a compute command, the compute server 120 allocates the tasks based on the computational power available at each geographically distributed site 160, the type of computation required, and the current workload. The information related to the power bandwidth may be provided by the power management server 110.

Similar to the power management server 110, the compute server 120 may take different suitable forms. For example, while the compute server 120 is described in a singular form, the compute server 120 may include one or more computers that operate independently, cooperatively, and/or distributively. In various embodiments, the compute server 120 may be a single server or a distributed system of servers that function collaboratively. It may be implemented as a cloud-based service, a local server, or a hybrid system in both local and cloud environments. In some embodiments, the compute server 120 may be a server computer that includes one or more processors and memory that stores code instructions that are executed by one or more processors to perform various processes described herein. In some embodiments, the compute server 120 may also be referred to as a computing device or a computing server. In some embodiments, the compute server 120 may be a pool of computing devices that may be located at the same geographical location (e.g., a server room) or be distributed geographically (e.g., cloud computing, distributed computing, or in a virtual server network). In some embodiments, the compute server 120 may be a collection of servers that independently, cooperatively, and/or distributively provide various products and services described in this disclosure. The compute server 120 may also include one or more virtualization instances such as a container, a virtual machine, a virtual private server, a virtual kernel, or another suitable virtualization instance.

While in the computing environment 100 illustrated in FIG. 1 the power management server 110 and the compute server 120 are depicted as two separate servers, in some embodiments the power management server 110 and the compute server 120 are the same server. For example, a server may perform both the allocation of compute tasks and monitor and manage the power consumptions of various compute nodes 162 at the geographically distributed sites 160. In other embodiments, the power management server 110 and the compute server 120 are separate servers. For example, the compute server 120 may be operated by a model developer that requires a substantially large amount of compute resources to train a large model, while the power management server 110 may be operated by a power management provider that generates power management data for the compute server 120 to make decisions related to the allocation of computes to improve power cost and consumption.

In the context of machine learning operations, such as training a large model, the compute server 120 would distribute the training tasks among various compute nodes so that each node is efficiently utilized without exceeding its power capacity or computational limits. In some embodiments, the machine learning models that require various data processing tasks are large models such as large language models (LLMs) that are trained on a large corpus of training data to generate outputs. A large model may be trained on massive amounts of training data, often involving billions of words, text units, images, or other types of training data. A large model may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since a large model has a significant parameter size and the amount of computational power for inference or training the large model is high, the large model may be deployed on an infrastructure with a distributed data center illustrated in the computing environment 100 in FIG. 1 to allocate the compute tasks among different various compute nodes 162 that are geographically distributed in different sites. In one instance, the primary copy of the large model may be hosted on a cloud infrastructure service. The large model may be trained on a large amount of data from various data sources. The training data and relevant weights may be transmitted to each individual compute node 162 for the compute node 162 to perform part of the computation.

The computing environment 100 may include various data stores 130 that store different types of data for different entities. For example, the compute server 120 may store weights of trained models in a data store 130. In some embodiments, a data store 130 may also store data sets needed for computation, intermediate results, configuration files, and other metadata. The power management server 110 may also store, in a data store 130, various power usage data and pattern data of geographically distributed sites 160 in a data store 130. Those power-related data, including usage, bandwidth, rate plan, consumption patterns, etc., may be referred collectively to as power management data.

A data store 130 includes one or more storage units, such as memory, that take the form of a non-transitory and non-volatile computer storage medium to store various data. The computer-readable storage medium is a medium that does not include a transitory medium, such as a propagating signal or a carrier wave. In one embodiment, the data store 130 communicates with other components by the network 180. This type of data store 130 may be referred to as a cloud storage server. Examples of cloud storage service providers may include AMAZON AWS, DROPBOX, RACKSPACE CLOUD FILES, AZURE, GOOGLE CLOUD STORAGE, etc. In some embodiments, instead of a cloud storage server, a data store 130 may be a storage device that is controlled and connected to a server, such as the power management server 110. For example, the data store 130 may take the form of memory (e.g., hard drives, flash memory, discs, ROMs, etc.) used by the server, such as storage devices in a storage server room that is operated by the server. The data store 130 might also support various data storage architectures, including block storage, object storage, or file storage systems. Additionally, it may include features like redundancy, data replication, and automated backup to ensure data integrity and availability. The data store 130 can be a database, data warehouse, data lake, etc.

A client device 140 may also be referred to as a user device. A client device 140 may be controlled by a client. The client may be a user of the power management server 110 or a user of the compute server 120. A client device 140 may initiate requests for computations within the distributed compute system. For example, the client device 140 may be a device that requests computation that involves the use of a machine learning model, whether the computation is related to training the model or making inferences using the model. Different types of clients may be involved in the computing environment 100. For example, a client may be an end user that uses an application powered by a machine learning model. The use of the machine learning model may cause the compute server 120 to distribute the data processing tasks among various compute nodes 162 in a distributed data center. A client may also be an engineer who may cause the training (e.g., initial training, retraining, fine-tuning, etc.) of a machine learning model. The training is distributed among various compute nodes 162 in a distributed data center. In some embodiments, a client may also be a user of the power management server 110, such as an operator of the compute server 120, who manages the power consumption and distribution of various compute nodes 162.

The client device 140 may be any computing device. Examples of client devices 140 include personal computers (PC), desktop computers, laptop computers, tablet computers, smartphones, wearable electronic devices such as smartwatches, or any other suitable electronic devices. A client device 140 may include a user interface and an application. The user interface may be the interface of the application and allow the user to perform various actions associated with the application. For example, the application may be a software application, and the user interface may be the front end. The user interface may take different forms. In some embodiments, the user interface is a graphical user interface (GUI) of a software application. For example, the power management server 110 may provide power management software that provides data and analytics related to various compute nodes 162. In some embodiments, the front-end software application is a software application that can be downloaded and installed on a client device 140 via, for example, an application store (App store) of the client device 140. In some embodiments, the front-end software application takes the form of a webpage interface that allows users to perform actions through web browsers. A front-end software application includes a GUI that displays various information and graphical elements. In some embodiments, the GUI may be the web interface of a software-as-a-service (SaaS) platform that is rendered by a web browser. In some embodiments, the user interface does not include graphical elements but communicates with a server or a node via other suitable ways, such as command windows or application program interfaces (APIs).

A data center 150 may be a commercial data center, which is a facility equipped with high-performance computing resources that perform data processing tasks as part of the distributed compute system. The data center 150 may include racks of servers (e.g., racks of processors, such as GPUs), storage units, and networking equipment designed to handle large-scale data processing operations. In some embodiments, the data center 150 serves as a central hub for executing compute tasks that require significant processing power, such as training machine learning models, performing large-scale simulations, handling big data analytics, or mining cryptocurrencies. In some embodiments, the data center 150 may perform a data processing task with other compute nodes 162 in geographically distributed sites 160 in a distributed manner. In some embodiments, the data center 150 may be considered as one of the compute nodes 162 or multiple compute nodes 162.

The role of a data center 150 in a distributed data center may vary in different embodiments. In some embodiments, the data center 150 may serve as the main computing source for computing tasks related to the compute server 120 and the compute nodes 162 in geographically distributed sites 160 may serve as supplemental computing sources. In some embodiments, instead of being treated as the main source, the data center 150 may be treated as one of the compute nodes 162. In some embodiments, the distributed data center only uses compute nodes 162 in geographically distributed sites 160 and does not use a data center 150 at all.

A distributed data center includes a plurality of compute nodes 162 that are located in various geographically distributed sites 160 and/or in a commercial data center 150. The compute nodes 162 perform a data processing task in a distributed manner. A compute node 162 may include one or more processors, which are integrated circuits that are used for performing computations, such as central processing units (CPU), graphics processing units (GPU), tensor processing units (TPU), other any suitable AI processors that accelerate the computations related to machine learning models. A compute node 162 may correspond to a single processor or a group of processors (e.g., 8 GPUs that are controlled by hosted CPUs in a rack of processors). Some compute nodes 162 may reside in a data center 150, while other compute nodes 162 may each reside at a geographically distributed site 160. In some embodiments, the computing system at geographically distributed sites 160 is modular and allows the addition of compute nodes 162.

Geographically distributed sites 160 refer to various locations that house compute nodes 162 for performing computation in a distributed manner. The sites 160 are separated geographically. The geographically distributed sites 160 can be any suitable locations, including residential units such as individual dwellings and multifamily dwellings, commercial buildings, office locations, and industrial buildings. For example, in some embodiments, the geographically distributed sites 160 may include a number of residential dwellings where the compute nodes 162 are installed to form a distributed data center. A geographically distributed site 160 may have a non-data processing load 166, which may be referred to as an individual load or a collective load of the power that is consumed at the geographically distributed site 160. For example, a non-data processing load 166 may refer to, individually or collectively, any electrical power consumption source that is not associated with the operation of a compute node 162, such as the lighting, appliances, electronics, electric vehicle charging, other household loads, and/or a collection of those loads.

In some embodiments, a geographically distributed site 160 is installed with a power management unit 164 to monitor the power consumption of the non-data processing load 166. A power management unit 164 may take the form of a smart electrical panel, a sub-electrical panel, or a separate monitor unit that is connected to a conventional unintelligent electrical panel. The power management tasks performed by the power management unit 164 may include simple circuit breaking or more intelligent tasks such as monitoring individual load’s usage, generating analytics, tracking power consumption, recommending power usage based on rate plan, charging a battery at a selected time to reduce power cost, etc. In some embodiments, the power management unit 164 is a smart electrical panel that controls the power consumption of the non-data processing load 166 and the compute node 162. In some embodiments, the power management unit 164 is a sub-panel or an individual unit as an add-on for a geographically distributed site 160 that uses a conventional unintelligent electrical panel.

In some embodiments, the power management units 164 are in communication with the power management server 110 to provide power consumption or prediction data of individual geographically distributed sites 160 to the power management server 110. Based on the data, the power management server 110 may provide the data or analytics to the compute server 120 to indicate the power bandwidth availability for the distributed data center collectively or for each compute node 162 individually. For example, in some embodiments, for a particular compute node 162, the power management unit 164 may monitor the power consumption of the non-data processing load 166 and provide the remaining power bandwidth not used by the non-data processing load 166 to the compute server 120 for data processing tasks. The power management server 110 may also provide data for the compute server 120 to allocate compute based on the power cost. For example, if a particular location of a geographically distributed site 160 has a high power cost at a particular time window, the compute allocation to the compute node 162 at the site may be reduced, and vice versa. In some embodiments, the power management server 110 may define a particular distributed data center that includes various geographically distributed sites 160. The overall power bandwidth of the distributed data center may be determined based on the collection of data transmitted by the various power management units 164 at those geographically distributed sites 160.

The communications among the power management server 110, compute server 120, data store 130, client device 140, data center 150, and various compute nodes 162 may be transmitted via a network 180. In some situations, a network 180 may be a local network. In some situations, a network 180 may be a public network such as the Internet. In one embodiment, the network 180 uses standard communications technologies and/or protocols. Thus, the network 180 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 180 can be represented using technologies and/or formats, including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 180 also includes links and packet-switching networks such as the Internet.

By distributing compute nodes 162 to various geographically distributed sites 160, such as various residential dwellings, the allocation of computes in a complex data processing task is improved in various aspects such as latency, power consumption, load balancing, and bandwidth. For example, if the complex data processing task is completed solely at a data center 150, the power consumption and compute allocation may not be optimized based on latency between the data center 150 and the source of the data, timing of the computation, and allocation of compute nodes 162. In some embodiments, data related to the power bandwidth and rate plan of individual compute nodes 162 are provided to a compute server 120 for the compute server 120 to determine the allocation of the data processing tasks to the compute nodes 162. In some embodiments, the allocation is at least partially based on power consumption at the geographically distributed sites 160 monitored by the power management unit 164.

In some embodiments, the use of distributed data centers addresses the rapidly increasing energy consumption driven by the growth of AI-powered data centers. According to industry research, the energy consumption of AI-driven data centers is projected to escalate significantly, with an expected rise from 4.9% of U.S. electricity consumption in 2023 to 9.1% by 2030. This surge is partly due to the substantial energy demands of AI-related tasks, such as those performed by models like ChatGPT, which consume approximately 2.9Wh per search query—nearly ten times the energy consumed by traditional search queries. The typical construction timeline for a large-scale data center, ranging from 100MW to 1000MW, is 1 to 2 years, contingent on the availability of interconnection points and specialized regional labor. Moreover, the market for colocation data centers has seen a significant increase in lease pricing, with the average asking rental rate for 250-500kW colocation facilities rising by 18.6% year-over-year to a record $163.44 per kW/month. The deployment of distributed data centers addresses the issues caused by these trends. The compute nodes 162 can be installed behind residential meters and paired with battery energy storage and photovoltaic (PV) systems. By leveraging these distributed resources, a distributed data center aims to meet the growing demand for compute power while offering a more sustainable and decentralized approach to data center deployment.

### Micro Data Center Site Configurations

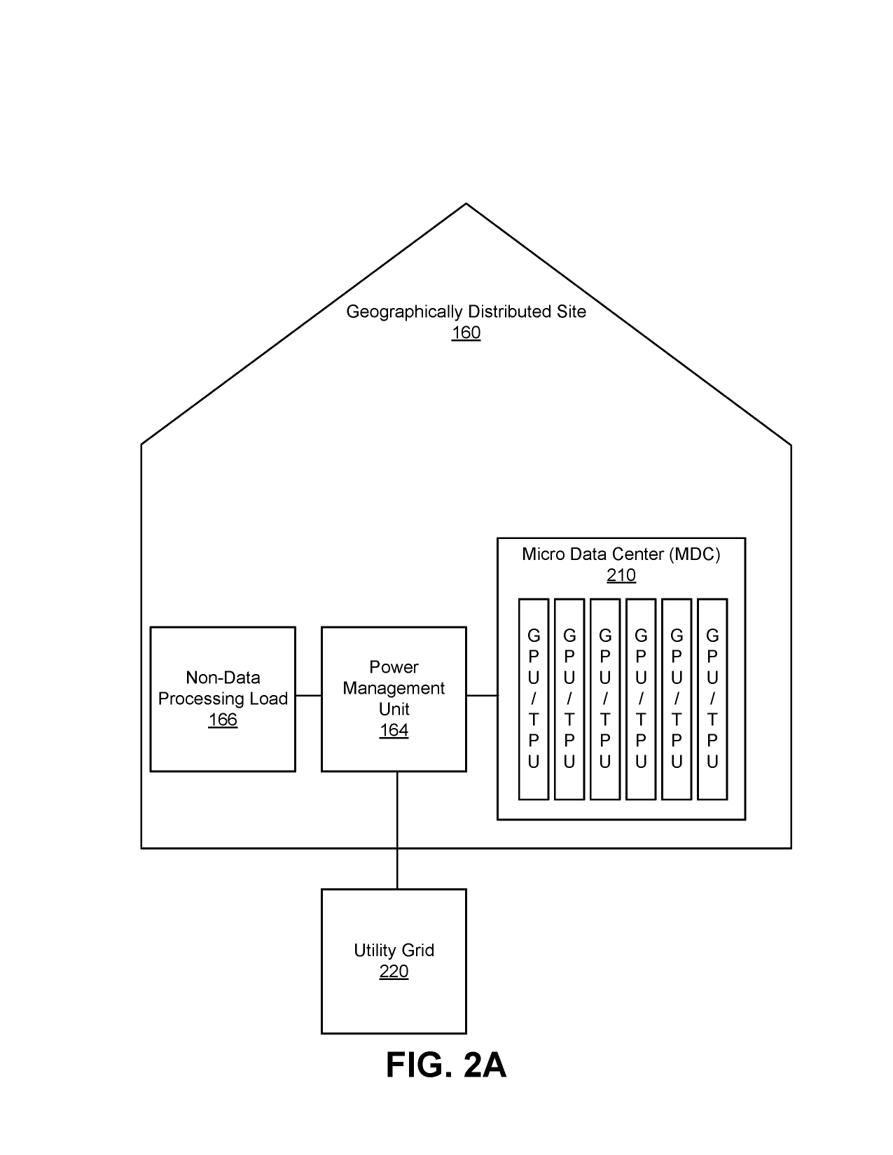

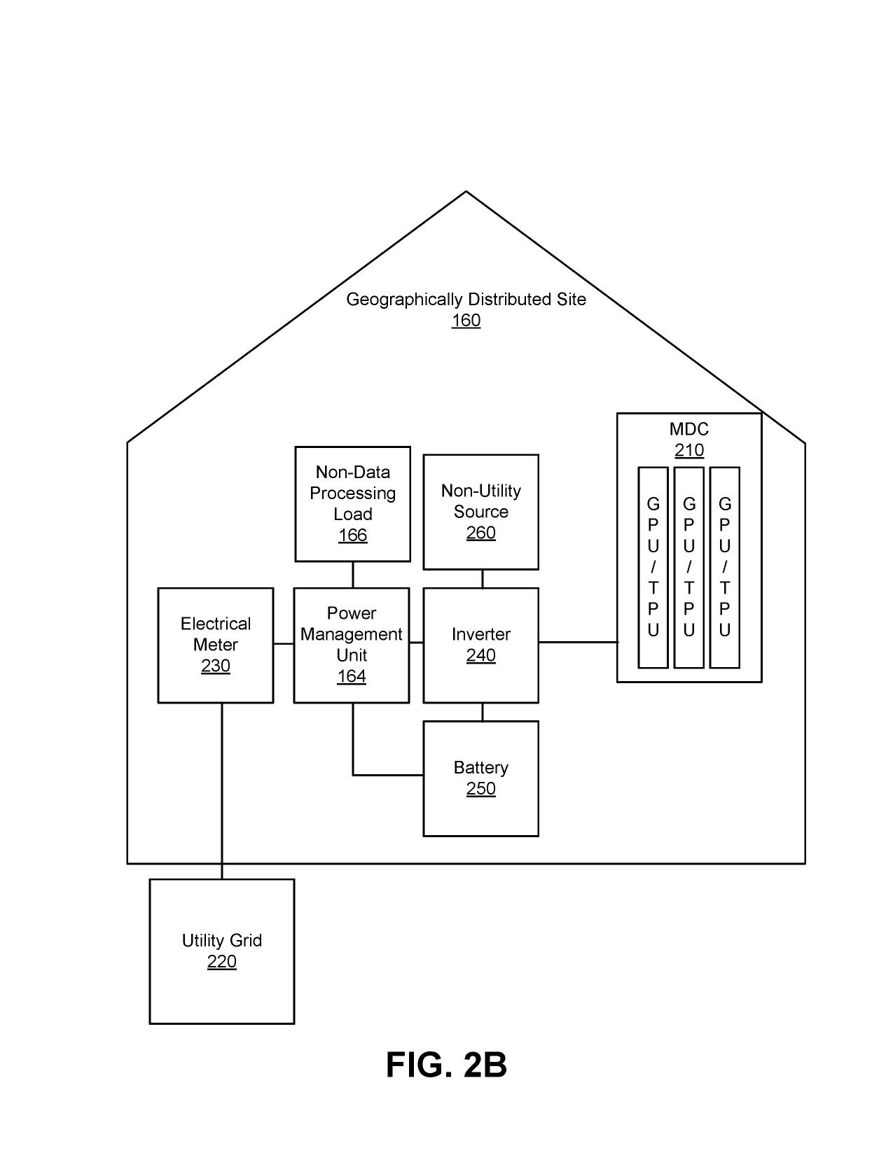

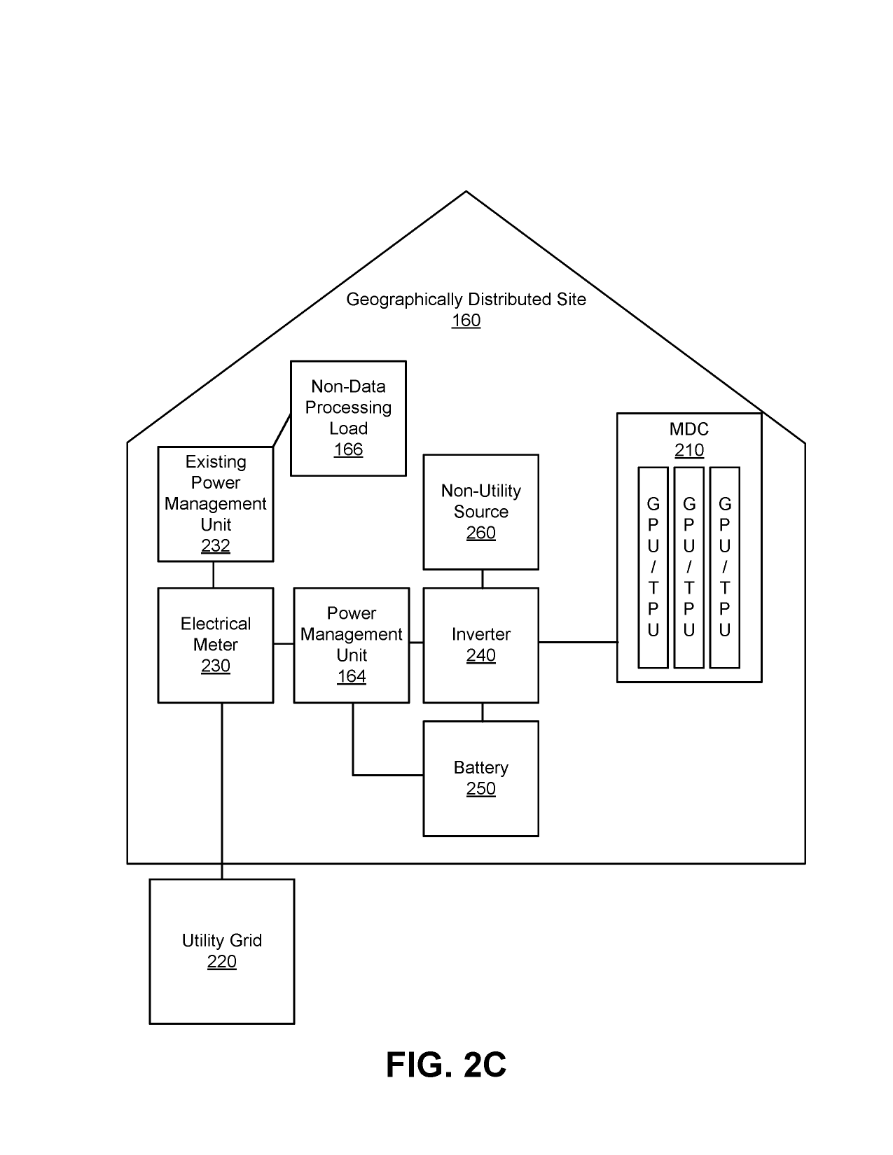

FIG. 2A is a conceptual diagram illustrating a micro data center (MDC) at a geographically distributed site, in accordance with some embodiments. While the geographically distributed site 160 is depicted as a symbol that resembles a house, the geographically distributed site 160 can also be any suitable site as discussed in FIG. 1. The geographically distributed site 160 includes the non-data processing load 166, the power management unit 164, and an MDC 210.

The MDC 210 includes one or more integrated circuits, such as one or more processors, for performing data processing tasks such as any computations related to machine learning models or related to any suitable complex computations. The MDC 210 may be considered as a single compute node 162 or multiple compute nodes 162, depending on how a compute server 120 determines to distribute the computation tasks. While the processors are depicted as a stack of GPUs or TPUs, any number and suitable type of processors are possible in various embodiments, such as central processing units (CPU), graphics processing units (GPU), tensor processing units (TPU), other any suitable AI processors that accelerate the computations related to machine learning models. In some embodiments, the stack of processors may be data-center graded (e.g., NVIDIA H100, A100, H800, BLACKWELL, AMD MI300, GOOGLE TPU), which are not personal computer processors.

For example, in some embodiments, an MDC 210 includes a stack of GPUs or TPUs that can be hosted or leased by an operator of a distributed data center using a standard power interface. In some embodiments, an MDC 210 can be modular, and additional stacks of processors may be added module by module. This modular approach enables rapid deployment of MDC 210 to expand a distributed data center based on the available power at each geographically distributed site 160, maximizing compute capacity “behind the meter.” In some embodiments, the MDC 210 may also be referred to as modular data center 210 or modular compute nodes. The set of modular compute nodes is removable and addable individually node by node at the geographically distributed site 160.

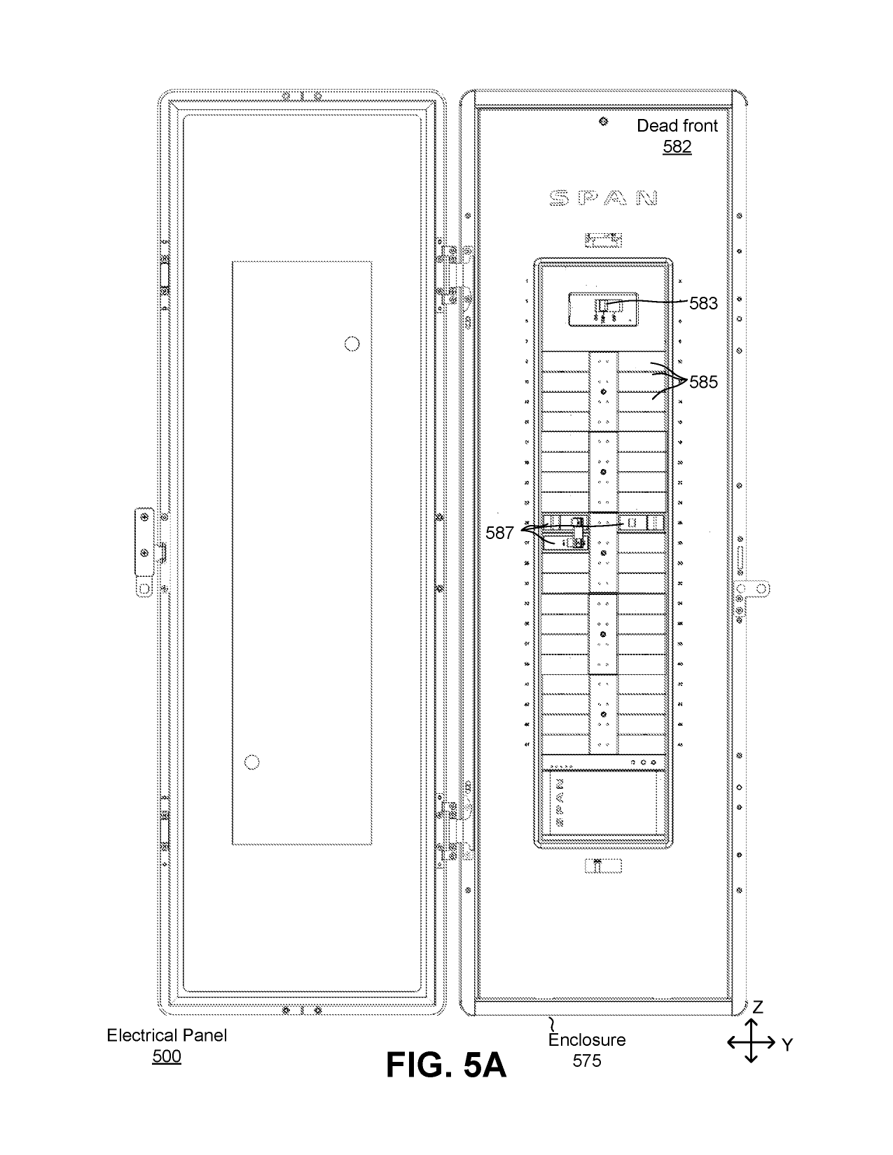

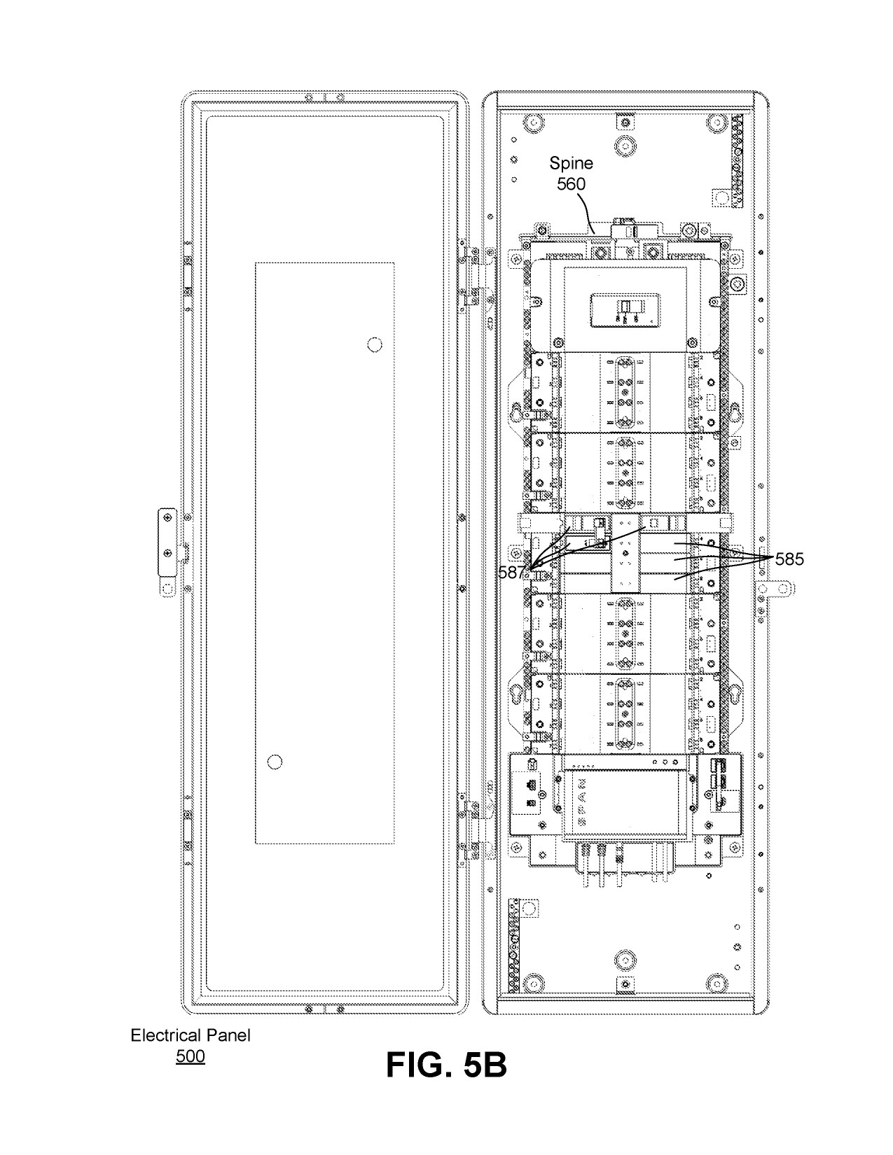

The MDC 210 is connected to a power management unit 164, which may take the form of a smart electrical panel. The power management unit 164 is connected to the non-data processing load 166, the MDC 210, and a utility grid 220. The power management unit 164 draws power from the utility grid 220 and allocates the power to the non-data processing load 166 and the MDC 210. In some embodiments, the allocation of power prioritizes the non-data processing load 166 as the non-data processing load 166 is the primary use of the geographically distributed site 160. The remaining power bandwidth is reported by the power management unit 164 to the power management server 110 (not shown in FIG. 2A) for the power consumption of the MDC 210. An example design of a power management unit 164 is further illustrated in FIG. 5A and FIG. 5B.

FIG. 2B is a conceptual diagram illustrating a micro data center (MDC) at another geographically distributed site, in accordance with some embodiments. The geographically distributed site 160 includes a non-data processing load 166, an electrical meter 230, a power management unit 164, an inverter 240, a battery 250, an MDC 210, and a non-utility source 260. In some embodiments, one or more components may be combined, and some components may not be present. For example, FIG. 2B illustrates an embodiment where the electrical meter 230 and the power management unit 164 are separate. This can be the case where the electrical meter 230 is a conventional unintelligent electrical meter and the power management unit 164 is a sub-panel or an intelligent electrical panel for managing the power consumption at the geographically distributed site 160. In some embodiments, the power management unit 164 is a smart electrical meter 230 and the two components may be combined. In some embodiments, the non-utility source 260 is not present.

In some embodiments, the power management unit 164 may provide a smart energy management system that improves a site’s electrical capacity without requiring a service upgrade. The smart energy management system may be referred to as PowerUp. The smart energy management system manages power loads across circuits, allowing the addition of high-demand appliances like EV chargers and HVAC systems that the home might not normally support. The smart energy management system automatically manages specific high-demand appliances, such as electric vehicle (EV) chargers, resistive water heaters, and certain HVAC equipment, to keep the total incoming power below the home's service rating. Homeowners can prioritize appliances through a software application associated with the power management unit 164, ensuring efficient power distribution. For instance, the system can prioritize EV charging through the power management unit 164, dynamically adjusting the charge rate based on available power. In some embodiments, the smart energy management system continues to manage circuits based on the latest settings at the time if the internet connection is lost.

In some embodiments, the power management unit 164 may include network components that serve as communicate gateway for the MDCs 210. For example, the power management unit 164 may serve as communicate gateway that provide Internet, data storage, and AI capabilities to the homeowner or a network of homeowners. For example, with the amount of bandwidth available by connecting the MDC and using the on-device Wi-Fi AP capabilities, the power management unit 164 may also broadcast Internet to the users. the power management unit 164 may also allow the users to access the processors of the MDCs 210 for specialized tasks like modeling & inferring from the users’ energy consumption data or personal data. Also, the power management unit 164 can provide that as a secure, on-premise data storage solution for the end uses.

In some embodiments, the power management unit 164 may also authenticate the MDC 210 to allow the processors in the MDC 210 to participate in a distributed data center to perform computations. For example, the MDC 210, each module of processors, or each processor may be individually registered with the compute server 120 or with the power management server 110 (not shown in FIG. 2B) in order to participate in a distributed data center. The MDC 210 may include a secure enclave or key management hardware that stores a private cryptographic key for the authentication and encryption process. The MDC 210 may be authenticated through the power management unit 164 or directly to the power management server 110 or compute server 120 before the MDC 210 can participate in a distributed data center. In some embodiments, the data allocated to the MDC 210 for computation may also be encrypted using the public cryptographic key of the MDC 210 so that the data can be securely transmitted to the MDC 210 for computations.

In some embodiments, the encryption mechanism described above provides solutions to issues related to the deployment of decentralized compute nodes 162. These issues include considerations about the security and cost-effectiveness of decentralized solutions compared to traditional large data centers or co-location facilities. There are also concerns about the risk of theft or security breaches, the sufficiency of communication bandwidth between decentralized nodes, and the adaptability of the physical architecture to external environmental changes, similar to advancements seen in battery technology. Additionally, a distributed data center raises questions about whether power management server 110 will need to own compute and communications infrastructure to fully realize the value of the distributed data center and whether regulatory frameworks will evolve to address the high costs and timelines associated with deploying large data centers. Finally, a distributed data center considers potential consumer issues around data privacy and security, which may emerge as the distributed data center is deployed on a larger scale.

In some embodiments, an MDC 210 is designed to integrate a bi-directional inverter 240 (e.g., 11.5kW AC bi-directional inverter) with an extensible DC bus (e.g., a 15kW DC bus), providing direct power to the compute stack. Additionally, or alternatively, the MDC 210 may feature a battery 250 (e.g., 6kWh lithium iron phosphate (LFP) battery) capable of backing up for the MDC 210 as well as essential household loads. The battery 250 may also be modular to add additional batteries. To enhance efficiency, a shared liquid cooling system may be implemented to manage the thermal load of the power electronics, energy storage, and compute cluster. The power management unit 164, in some cases provided by the company that operates the power management server 110, with the PowerUp technology allows for the addition of an MDC 210 (e.g., a 5kW MDC) without necessitating a service upgrade, enabling seamless integration into existing residential power infrastructures. This integrated approach to power and thermal management allows a distributed data center to operate efficiently and sustainably, providing reliable computing power while minimizing the impact on the local utility grid 220.

A non-utility source 260 can be any power source that is not part of the local utility grid 220. For example, the non-utility source 260 can be the solar panel installed at the geographically distributed site 160, an electric vehicle that is connected to the inverter 240, or a power generator. The non-utility source 260 may provide power directly to the MDC 210 or through the storage of the battery 250.

The use of battery 250 may also allow the optimization of energy and cost for using an MDC 210. For example, at a low power consumption period or low-cost period, power can be drawn from the local utility grid 220 or the non-utility source 260 to store the energy at the battery 250. In turn, the battery 250 may be used to power the MDC 210.

In some embodiments, different operation models are possible for deploying a distributed data center, such as a hosted compute model and a leased compute model. Under the hosted compute model, power management server 110 provides the power and cooling infrastructure, such as the power management unit 164, the inverter 240, and the battery 250, for a third-party MDC 210 to be easily installed in the geographically distributed site 160. The third-party MDC 210 may be owned by the compute server 120. This approach mitigates risks associated with security and networking. Conversely, the leased compute model involves power management server 110 generating the specification of an MDC 210 and providing an MDC 210 as a factory-assembled solution, which AI, machine learning, and data companies can access for a fee as part of a distributed data center that may be operated by the power management server 110. These models offer flexibility in how the distributed data centers and corresponding compute nodes 162 (e.g., MDCs 210) are deployed.

FIG. 2C is a conceptual diagram illustrating a configuration where the power management unit 164 serves as a sub-panel, in accordance with some embodiments. In some embodiments, a meter-intercept approach may be used to simply the installation of MDC 210. The meter-intercept approach allows the installation to be performed by a technician rather than requiring expensive electrician labor. In this approach, the MDC 210 is a separate circuitry that is managed by a sub-panel that is separated from the main existing panel 232 (existing power management unit 232) that manages the non-data processing load 166. The sub-panel is the power management unit 164. The meter-intercept approach allows precise measurement of the energy consumption of the MDC 210. The power management unit 164, combined with the PowerUp technology, enables whole-home electrification for users while also contributing to the distributed computation of a distributed data center through the on-premises MDC 210. This design streamlines deployment reduces costs, and creates new revenue opportunities for both users and power management server 110.

The configurations illustrated in FIGS. 2A, 2B,or 2C enable an energy management system (EMS) that is able to operate an MDC 210 installed behind a user’s meter, such as a meter at a geographically distributed site 160. The EMS allows the MDC 210 to be powered by the user’s unused electrical service capacity by measuring in real time the unused capacity and allocating that capacity to the MDC 210. Connecting multiple such systems installed within a particular geography creates a distributed data center (DDC) that can be hosted or leased by third parties. The EMS allows for the addition of the MDC 210 without the need for a customer service upgrade. The MDC may be a standalone component or may be integrated into a hardware stack featuring a bidirectional inverter with a DC bus that can directly power the compute stack. Another configuration may feature a compute stack powered by the AC output of the inverter. One or more modular batteries (such as lithium iron phosphate, or LFP batteries) may be connected to the stack to power the MDC and essential loads. A shared liquid cooling system may be included to deliver increased efficiency for the power electronics, energy storage, and compute cluster. Alternatively, or additionally, the hardware stack may be an AC compute unit with an integrated power supply which is connected to and power controlled by the EMS.

In some embodiments, the homeowner may prioritize the loads to be controlled, and EMS is able to allocate capacity between home loads and the MDC 210 based on grid restraints and customer priorities. In some embodiments, the homeowner may be presented with the option to reduce or shed certain loads during times of peak MDC demand in exchange for certain benefits, such as energy savings or credits.

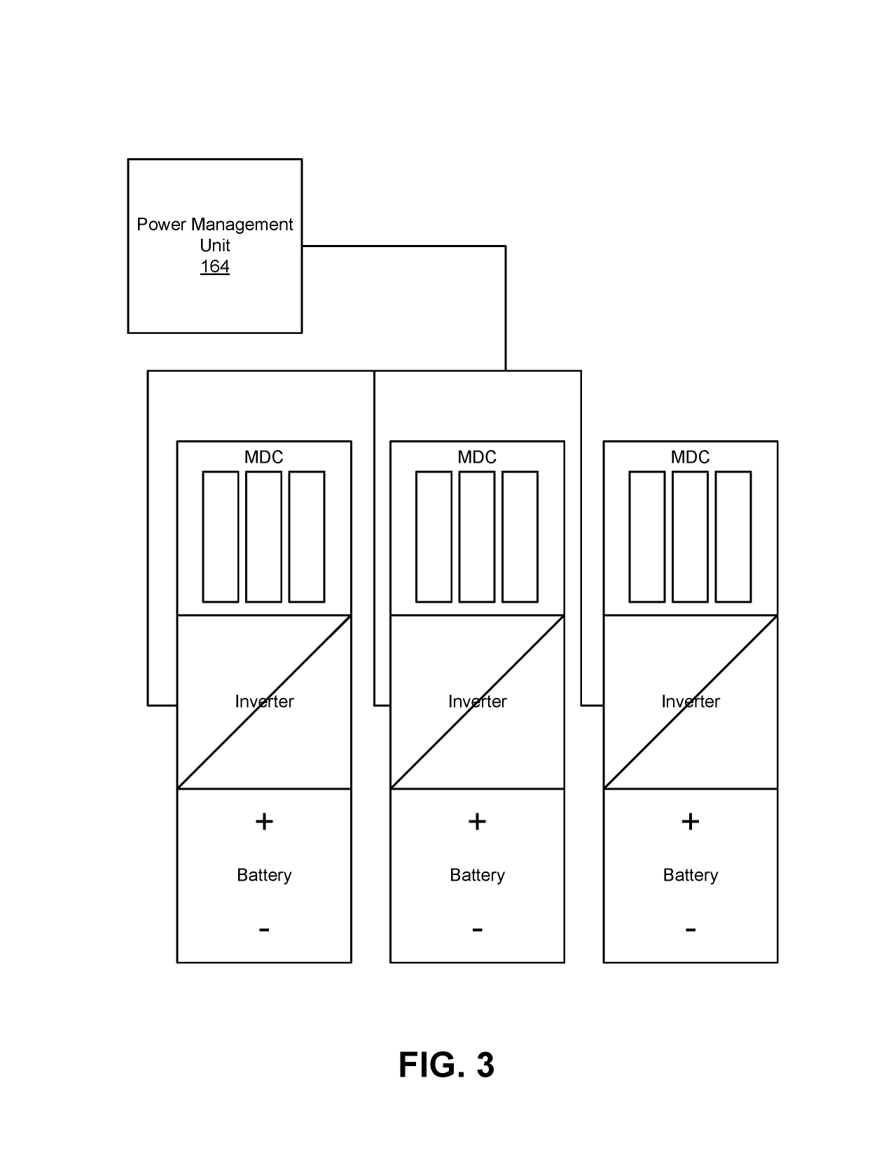

FIG. 3 is a conceptual diagram illustrating modular data centers 210, in accordance with some embodiment. In some embodiment, each module of MDC 210 may include an inverter 240 and a battery 250. In some embodiments, the MDC 210 is designed to be highly scalable, allowing for multiple MDCs 210 to be installed at a single geographically distributed site 160. The MDCs 210 are stackable, with inverters 240 designed for AC stackable and batteries 250 for DC stacking. This modular approach enables rapid deployment of MDCs 210 based on the available power at each site, maximizing compute capacity “behind the meter.” By allowing MDCs 210 to be installed in clusters, a distributed data center offers a flexible solution for scaling compute resources in response to growing demand. A single site may host multiple MDCs connected to and managed by one EMS. These clusters can effectively create a mini-DDC. The bi-directional inverters are designed to be AC stackable, and the batteries are DC stackable. Depending on available power at the site, an MDC or mini-DDC can be rapidly deployed to maximize compute behind the meter.

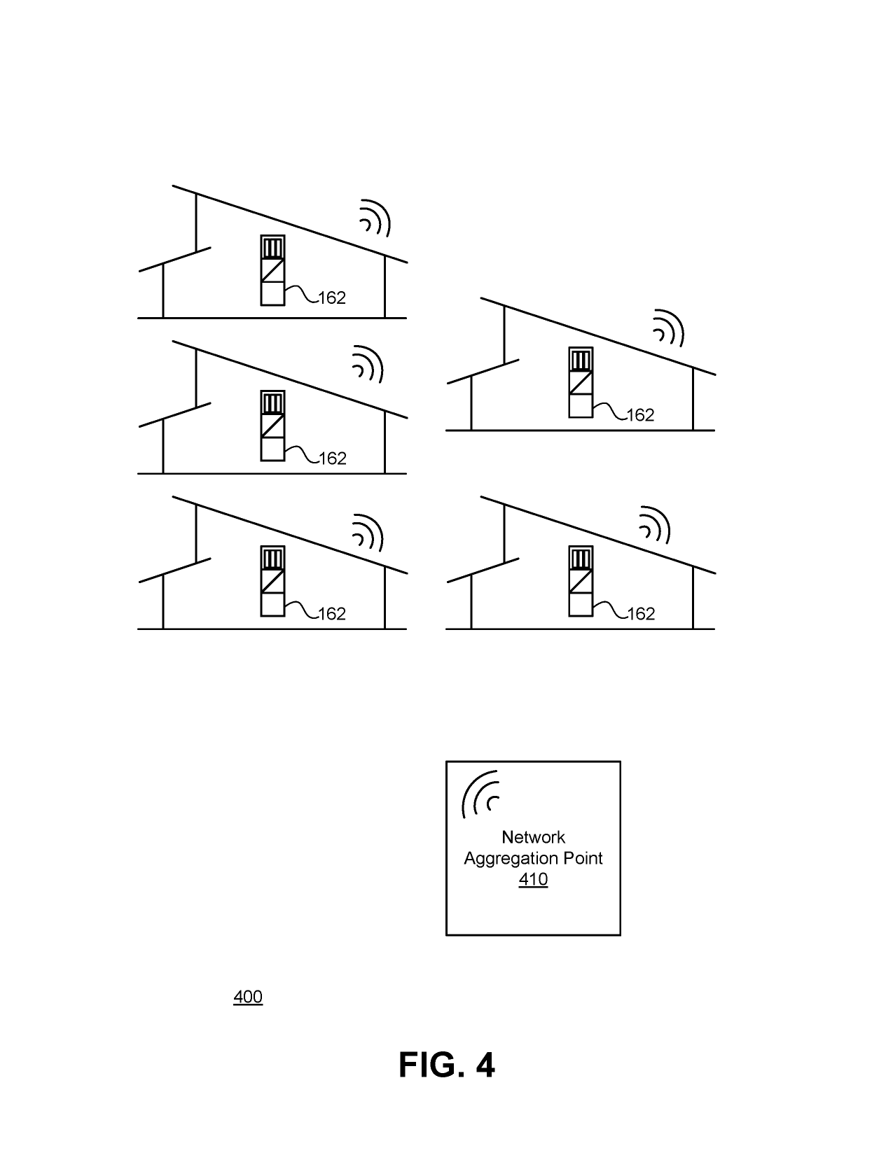

FIG. 4 is a conceptual diagram illustrating a network cluster 400 formed by a local group of compute nodes 162, in accordance with some embodiments. The MDCs 210 illustrated in FIG. 2A through 2C are examples of the various compute nodes 162. At least two compute nodes 162 may be connected via a communications protocol to create a mesh network. The mesh network may itself form a distributed data center or may participate as part of a larger distributed data center. Communication may be accomplished by Wi-Fi, cellular, mesh, broadband, or any other suitable protocol. In some embodiments, compute nodes 162 are connected to network aggregation point 410, such as a zonal aggregation point (ZAP) over a wireless mesh network. ZAP may be connected to the internet over high-speed fiber. In such a configuration, each compute node 162 in the mesh may also be used as an ISP hub to host the homeowner.

By way of example, in some embodiments, a distributed data center features an MDC mesh network, in which each compute node 162 connects to a network aggregation point 410 via a wireless mesh network. The network aggregation point 410 is then connected to the internet through a high-speed optical fiber. This network architecture allows each node to function not only as part of the compute network but also as an ISP hub for the host customer. This decentralized and scalable network design enhances connectivity, provides additional services to consumers, and improves the overall resilience of the distributed data center.

In some embodiments, the power management unit 164 can serve as the gateway for an MDC 210 connected to the power management unit 164. For example, the MDC 210 may not have network connectivity. Instead, the mesh network is formed by the power management unit 164.

In some embodiments, the data processing task is requested by a source and latencies from the plurality of compute nodes 162 to the source are measured to determine the distribution of the compute for the data processing task based on the latencies. For example, the mesh network is selected as the computation unit based on the latency between the mesh network and the source. The source may be a client device 140 or a data center 150.

In some embodiments, a distributed data center (DDC) provides a range of benefits to AI companies, consumers (end users), and utilities through the deployment of MDCs 210. For AI companies, the DDC architecture offers accelerated access to scalable compute resources and cleaner, cheaper energy per node. The decentralized design also provides enhanced privacy and resilience, while the modular structure simplifies maintenance, upgrades, and replacements. For consumers, the MDCs 210 lower fixed monthly utility costs or generate substantial revenue through on-premises compute operations, while also offering free home backup with best-in-class energy storage and avoiding costly service upgrades for home electrification. Additionally, consumers may gain access to high-speed ISP solutions through the DDC network 400. For utilities, the DDCs offer predictable and manageable growth in electricity demand, avoid the costs associated with large-scale generation, transmission, and distribution (GT&D) infrastructure, and increase the utilization of existing distribution networks. Furthermore, the DDCs enable customer electrification at no cost through the integration with the PowerUp technology.

### Smart Electrical Panel Design

FIGS. 5A and 5B are diagrams illustrating front views of a physical embodiment of a modular electrical panel 500. The modular electrical panel 500 is an example of a power management unit 164 that may be used in any geographically distributed sites 160. FIG. 5A is an end user's view of the modular electrical panel 500. In the end-user view, most of the electrical components are not physically accessible because they are hidden in an enclosure 575, under a dead front panel 582, and under modular dead front panels 585 (although the main breaker switch 583 and switches for three overcurrent circuit breakers 587 are accessible). FIG. 5B is a view of the electrical panel 500 with the dead front panel 582 removed and many of the modular dead front panels 585 removed. FIG. 5B illustrates various electrical component modules installed in a spine 560.

Conventional electrical panels on buildings (e.g., residential homes) are bulky, costly, and difficult to install, repair, replace, and upgrade. The modular electrical panel 500 overcomes these limitations with modular electrical components (also referred to as “electrical modules,” “chassis modules,” “modules,” or “electrical panel components”). These provide many advantages to installers and building owners: (1) the modular electrical panel can be rightsized for the usage needs of each building. For example, if a building will only use 16 branch circuits, the panel can be installed with just 16 branch circuits (e.g., instead of a larger number of circuits on a conventional preset panel), thus saving the building owner money. Additionally, an installer no longer needs to guess which components will be needed for a given building before arriving at the installation site. (2) The modular electrical components can be installed on many different types of electrical panels (e.g., used in different application settings). (3) The modular electrical components can be mass-produced (since the same set of modules can be installed on many different types of electrical panels). (4) Individual modular electrical components are easily accessible and can be easily replaced on-site without an installer removing large portions of the panel (e.g., without removing adjacent modules). (5) Modular electrical components on an electrical panel can be individually upgraded (e.g., with additional functionalities) without replacing or upgrading the entire electrical panel (or large portions of the panel). Examples of modular electrical panels and modular electrical components that provide one or more of the above advantages are further described below.

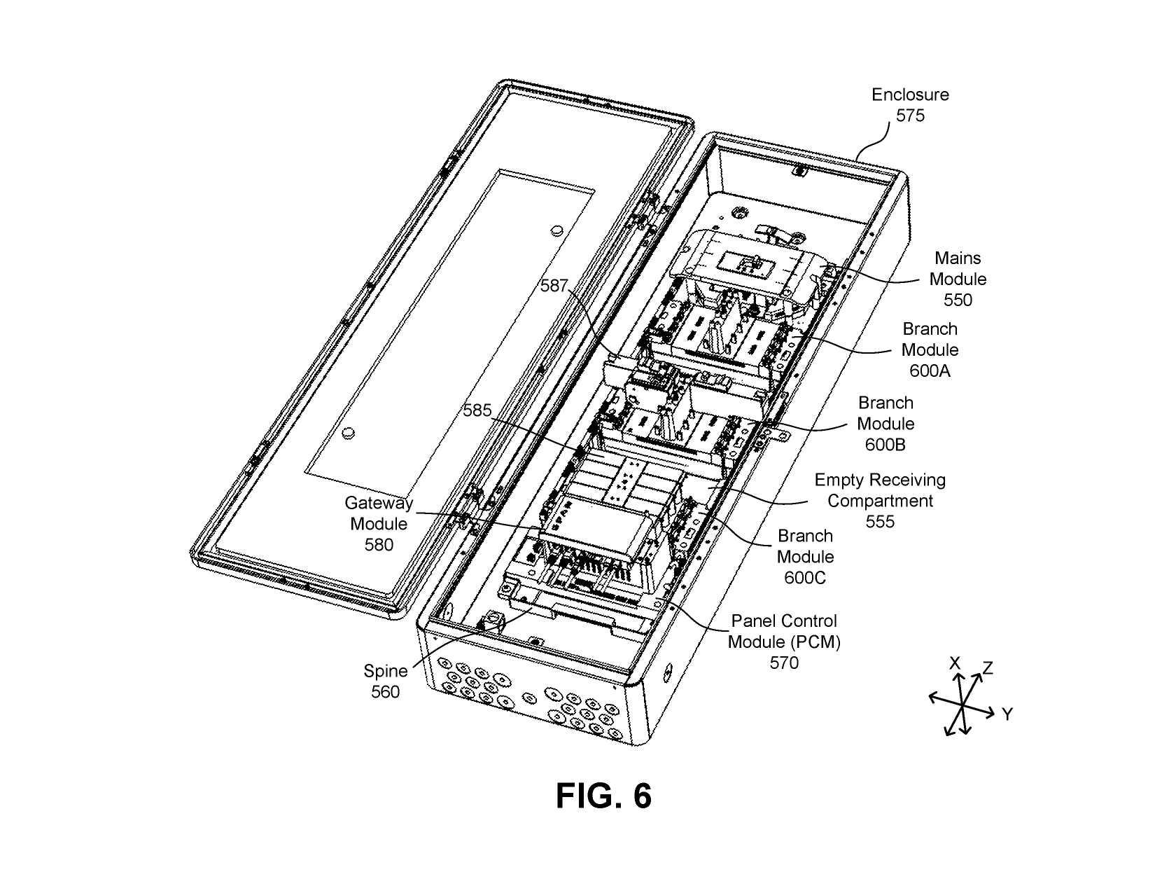

FIG. 6 is a perspective diagram of the electrical panel 500 with a different arrangement of electrical modules. Specifically, in the example of FIG. 6, the panel 500 includes (from top to bottom) a mains module 550, branch modules 600A-B, an empty module receiving compartment 555, a branch module 600C, a PCM 570, and a gateway module 580.

The mains module 550 may include the main breaker of the panel 500, a MID (Microgrid Interconnection Device), or some combination thereof (e.g., no main breaker and no MID). In some embodiments, the mains module 550 includes a main breaker and a MID. The mains module 550 may provide a location to connect the main feeders of the local utility grid 220 to the panel 500, provide overcurrent protection, and/or a disconnect. The mains module 550 may be rated up to 200 amps. If the mains module 550 includes an MID, the MID allows the panel 500 to isolate itself from the grid.

A branch module 600 is a modular electrical panel component that may be installed into one (e.g., of many) of the receiving compartments of the spine 560. Since a building (e.g., a residential building) may include many circuits, a panel may include multiple branch modules 600 to accommodate the expected electrical needs of the building. An example branch module 600 includes eight switched circuit branches (however additional or fewer circuits are possible for a branch module). Each circuit branch includes a stab which can engage with an overcurrent circuit breaker installed on the branch module 600. In some embodiments, the branch module 600 is rated up to 200 amps. The branch module 600 may include additional branch circuit functionalities, such as current or voltage sensing, AFCI protection, light (e.g., LED) indication, or some combination thereof for each circuit branch. An MDC 210 illustrated in FIG. 2A through FIG. 2C may be connected to one of the branch module 600.

A PCM 570 is a modular electrical component that may be installed in a receiving compartment of the spine 560. The PCM 570 may manage control of the electrical panel 500. For example, the PCM 570 performs computations (e.g., for PowerUp functionalities) and provides power to the other modules on the panel 500. The PCM 570 includes a user interface (UI) display that may give users (e.g., a homeowner) the ability to read the state of the panel 500 and interact with and control the panel 500. The PCM 570 may also monitor the power consumption of the non-data processing load 166 and the MDC 210.

The gateway module 580 is a site controller for a building (e.g., a residential home). If the building includes multiple panels, the gateway module 580 can receive and aggregate data from the multiple panels and determine building-wide control decisions and reports (thus, a building with multiple panels may only use a single gateway module). For example, the gateway module 580 determines decisions for powerup and can send panel reports to a cloud server (pending user permissions). The gateway module 580 may include computer components associated with the above functions, such as a set of processors, a computer-readable medium, and antennas. In some embodiments, the electrical panel 500, which is an example of a power management unit 164, can also serve as the gateway for an MDC 210 connected to the electrical panel 500. For example, the MDC 210 may not have network connectivity. Instead, the MDC 210 communicates to other nodes in the distributed data center through the electrical panel 500. The electrical panel 500 may also authenticate the MDC 210 before the MDC 210 can participate in a distributed data center. In some embodiments, the gateway module 580 of the electrical panel 500 also routes encrypted data to the MDC 210 so that data is secured.

In some embodiments, since the electrical panel 500 is modular, a compute node 162 may also be inserted as one of the modules, such as at the empty receiving compartment 555. For example, in some embodiments, an MDC 210 or an integrated circuit that includes a GPU, may be installed at the empty module receiving compartment 555. In other embodiments, the MDC 210 is installed separately from the electrical panel 500, which is an example of the power management unit 164.

In some embodiments, the power management unit 164 may include network components that serve as communicate gateway for the MDCs 210. For example, the power management unit 164 may serve as communicate gateway that provide Internet, data storage, and AI capabilities to the homeowner or a network of homeowners. For example, with the amount of bandwidth available by connecting the MDC and using the on-device Wi-Fi AP capabilities, the power management unit 164 may also broadcast Internet to the users. the power management unit 164 may also allow the users to access the processors of the MDCs 210 for specialized tasks like modeling & inferring from the users’ energy consumption data or personal data. Also, the power management unit 164 can provide that as a secure, on-premise data storage solution for the end uses. Those network components or backup data storage units may take the forms of modules that can be inserted into the electrical panel 500 shown in FIG. 6.

Although the descriptions herein are generally in the context of electrical panel 500, the descriptions herein are generally applicable to chassis that can receive modules and, more specifically, applicable to other types of electrical panels (e.g., the size of the panel and the number of modules may be different) which accommodate different electrical needs for different buildings. In the first example, a smaller panel includes three receiving compartments: a top receiving compartment with a mains module 550, a middle receiving compartment with a branch module 600, and a bottom receiving compartment with a PCM module 570. In the second example, a panel includes a top receiving compartment with a lug module, three middle receiving compartments with branch modules 600, and a bottom receiving compartment with a PCM module 570.

### Compute Allocation Process

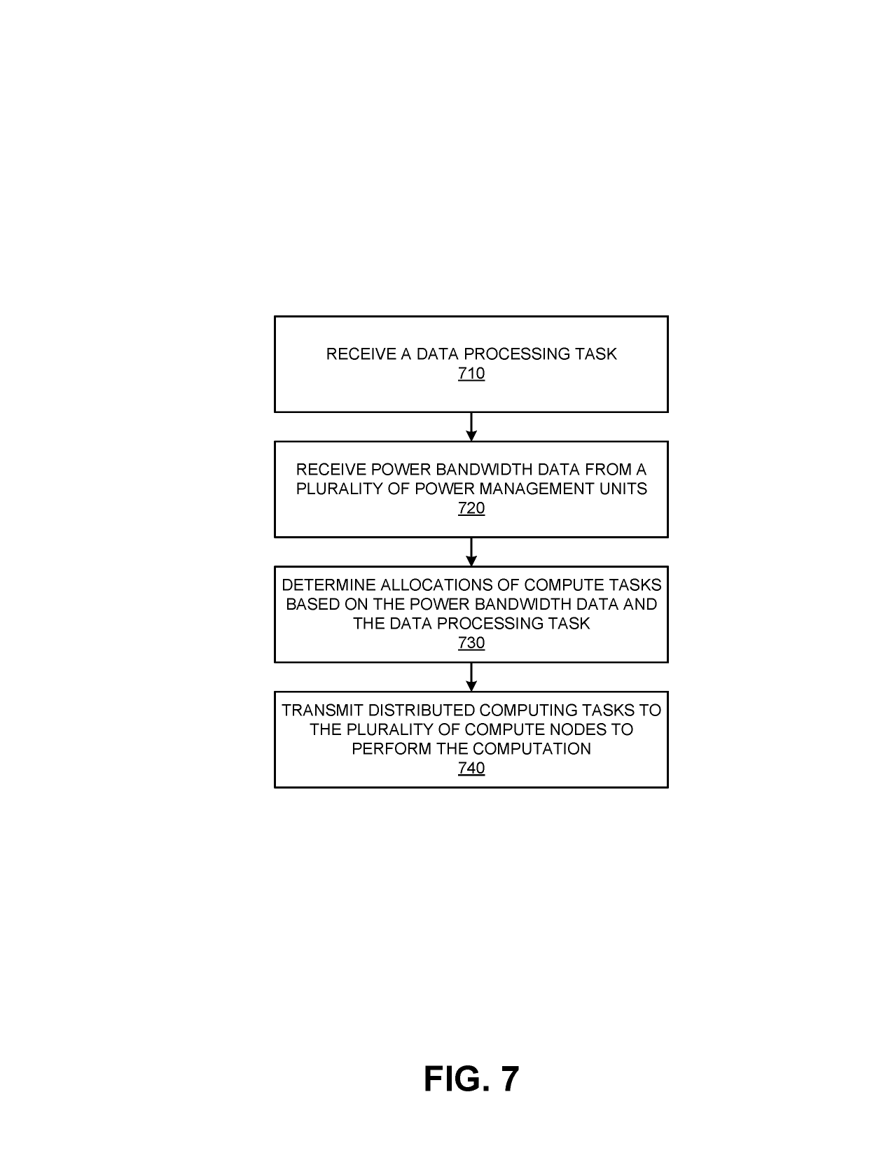

FIG. 7 is a flowchart depicting a process 700 for allocating data processing tasks to a plurality of compute nodes in a distributed data center, in accordance with some embodiments. The process 700 may be performed by the power management server 110 or the compute server 120, or a combination of power management server 110 and the compute server 120. For simplicity, the process 700 is described as being performed by a computing device. In various embodiments, the process 700 may include additional, fewer, or different steps.

In some embodiments, the computing device receives 710 a data processing task. The computing device receives 720 power bandwidth data from a plurality of power management units 164. The power management units 164 manage the power usage of a plurality of compute nodes 162 in a distributed data center. The computing device determines 730 allocations of compute tasks based on the power bandwidth data and the data processing task. The computing device transmits 740 distributed computing tasks to the plurality of compute nodes 162 to perform the computation in a distributed manner.

For example, a distribution of the compute for the data processing task is determined by receiving rate plan information of the geographically distributed sites. The computing device allocates power consumption of the compute among the plurality of compute nodes based on the rate plan information. The computing device regulates a determined allocation of the power consumption through the plurality of power management units 164.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A distributed compute system comprising:
a plurality of compute nodes located in geographically distributed sites, wherein a data processing task is performed in a distributed manner among the plurality of compute nodes; and
a first power management unit located in a first site of the geographically distributed sites, wherein the first site consumes electrical power for both a first compute nodes of the plurality of compute nodes and for a non-data processing load, and wherein the first power management unit monitors power consumption at the first site,
wherein an allocation of the data processing task to the first compute node is controlled at least partially based on power consumption at the first site monitored by the first power management unit.

2. The distributed compute system of claim 1, wherein the first site is a residential unit, the non-data processing load is a residential load, and the first power management unit is an electrical panel for the residential unit.

3. The distributed compute system of claim 1, wherein the plurality of compute nodes comprise a plurality of graphical processing units or tensor processing units that are installed at residential units, and the geographically distributed sites include the residential units.

4. The distributed compute system of claim 3, wherein the geographically distributed sites further include a second site that is a commercial data center that comprises a set of second compute nodes.

5. The distributed compute system of claim 1, wherein the first compute node is connected to a battery that is configured to store energy, and wherein the battery is configured to provide power to the non-data processing load and the first compute node.

6. The distributed compute system of claim 1, wherein the first site comprises a first electrical panel configured to measure the power consumption of the first compute node and a second electrical panel configured to measure the power consumption of the non-data processing load, wherein the first electrical panel is the first power management unit.

7. The distributed compute system of claim 1, wherein the first power management unit is connected to a set of modular compute nodes, the set of modular compute nodes are removable and addable individually node by node at the first site.

8. The distributed compute system of claim 1, wherein the data processing task is requested by a source and latencies from the plurality of compute nodes to the source are measured to determine the distribution of the compute for the data processing task based on the latencies.

9. The distributed compute system of claim 1, wherein a distribution of the compute for the data processing task is determined by:
receiving rate plan information of the geographically distributed sites;
allocating power consumption of the compute among the plurality of compute nodes based on the rate plan information; and
regulating a determined allocation of the power consumption through the plurality of power management units.

10. The distributed compute system of claim 1, wherein at least a subset of compute nodes is connected over a wireless mesh network to form a zonal aggregation point and the subset of compute nodes are configured to be used as a network node in the wireless mesh network.

11. A system comprising:
a stack of processors serving as a compute node, the stack of processors installed at a residential unit, the stack of processors being part of a distributed data center, which performs a data processing task and includes a plurality of compute nodes that perform the data processing task in a distributed manner; and
a power management unit located in the residential unit, the power management unit is configured to manage power consumption of a residential load of the residential unit and power consumption of the stack of processors,
wherein an allocation of the data processing task to the stack of processors is at least partially based on power consumption at the residential unit monitored by the power management unit.

12. The system of claim 11, wherein the power management unit is an electrical panel for the residential unit.

13. The system of claim 11, wherein the stack of processors is data-center graded and not personal computer processors.

14. The system of claim 13, wherein at least one of the compute nodes is located at a commercial data center that includes a set of compute nodes.

15. The system of claim 11, wherein the stack of processors is connected to a battery that is configured to store energy, and wherein the battery is configured to provide power to the residential load and the stack of processors.

16. The system of claim 15, wherein the battery and the stack of processors are connected to a bi-directional inverter.

17. The system of claim 11, wherein the stack of processors is part of a set of modular compute nodes, the set of modular compute nodes are removable and addable individually stack by stack at the residential unit.

18. The system of claim 11, wherein the data processing task is requested by a source and a latency from the stack of processors to the source is measured to determine the allocation for the data processing task based on the latency.

19. The system of claim 11, wherein a distribution of the compute for the data processing task is determined by:
receiving rate plan information of geographically distributed sites;
allocating power consumption of the compute among the plurality of compute nodes based on the rate plan information; and
regulating a determined allocation of the power consumption through the plurality of power management units.

20. The system of claim 11, wherein the power management unit and additional power management units are connected over a wireless mesh network to form a zonal aggregation point and the power management units are configured to be used as a network node in the wireless mesh network.
